(19) United States
(12) Patent Application Publication
(10) Pub. No.: US 2013/0174849 A1
(43) Pub. Date: Jul. 11, 2013

(54) OLFACTORY MODIFYING DEVICES AND RELATED METHODS

(71) Applicants: Robert E. Atkinson, White Bear Lake, MN (US); Jason Galdonik, Minneapolis, MN (US); Paul McLean, North Oaks, MN (US)

(72) Inventors: Robert E. Atkinson, White Bear Lake, MN (US); Jason Galdonik, Minneapolis, MN (US); Paul McLean, North Oaks, MN (US)

(73) Assignee: Prospex Medical III, New Brighton, MN (US)

(21) Appl. No.: 13/737,734

(22) Filed: Jan. 9, 2013

Related U.S. Application Data
(60) Provisional application No. 61/585,079, filed on Jan. 10, 2012.
(60) Provisional application No. 61/590,206, filed on Jan. 24, 2012.

(51) Int. Cl. A62B 23/06

(52) U.S. Cl. CPC A62B 23/06
USPC 128/206.11

(57) ABSTRACT

Olfactory devices and methods for partially or completely blocking, masking or otherwise reducing olfactory input to mitigate adverse responses thereto. In one embodiment, a method of treating a patient with an olfactory-triggered condition may include diagnosing the patient's olfactory-triggered condition. In response to the diagnosis, the method may further include placing an olfactory device over an olfactory area in a nasal cavity of the patient to mitigate the olfactory-triggered condition.

### CROSS-REFERENCE TO RELATED APPLICATIONS

The present application claims the benefit of U.S. Provisional Patent Application No. 61/585,079, filed Jan. 10, 2012, entitled Olfactory Blocking Device for Weight Loss; and U.S. Provisional Patent Application No. 61/590,206, filed Jan. 24, 2012, entitled Olfactory Blocking Devices and Methods, the entire disclosures of which are incorporated herein by reference.

### TECHNICAL FIELD

The present disclosure is directed to embodiments of devices and methods for at least partially reducing a patient's olfactory input. More particularly, the present disclosure is directed to embodiments of methods and devices for affecting a patient's sense of smell for, among other things, therapeutic or diagnostic purposes.

### BACKGROUND

The sense of smell is governed by the olfactory system, which can sense over one thousand different odorants. It is innately involved in our daily lives and can substantially influence our behavior. For example, when eating food, the brain integrates sensory inputs from the olfactory (smell) system and the gustatory (taste) system (including, e.g., tastes of sweet, sour, salty, bitter and/or umami) to render flavor, which can influence an individual's disposition to food, including, e.g., food selection.

The sense of smell is commonly exploited to influence such behaviors. Whether it's the smell of fresh bread from a bakery, the smell of popcorn at a movie theater, or the scent of perfume from a women's retail store, odorants are commonly used to affect and/or influence human behavior, particularly for purposes of consumption. However, blocking odorants or blocking the sense of smell has not been widely utilized to achieve behavior modification or to modify olfactory-triggered responses.

### SUMMARY

Embodiments of the present disclosure relate to, among other things, devices and methods for affecting a patient's sense of smell. Each of the embodiments disclosed herein may include one or more of the features described in connection with any of the other disclosed embodiments.

In one embodiment, a method of treating a patient with an olfactory-triggered condition may include diagnosing the patient's olfactory-triggered condition. In response to the diagnosis, the method may further include placing an olfactory device over an olfactory area in a nasal cavity of the patient to mitigate the olfactory-triggered condition.

Embodiments of the method may include one or more of the following features: the olfactory-triggered condition comprises nausea and vomiting; the olfactory-triggered condition comprises migraine headache; the olfactory-triggered condition comprises over-eating; the olfactory device is placed superior to an inferior turbinate to allow free breathing across the inferior turbinate; the olfactory device is placed superior to an inferior turbinate and a middle turbinate to allow free breathing across the middle turbinate and the inferior turbinate; the olfactory device is placed adjacent an olfactory mucosa; the olfactory device is placed in an apex of the nasal cavity; a first olfactory device is placed in the patient's right nasal cavity and a second olfactory device is placed in the patient's left nasal cavity; the olfactory device comprises a non-absorbent material; the olfactory device is expandable from a smaller delivery configuration to a larger deployed configuration; the olfactory device comprises a material configured to dissolve in-situ; the olfactory device comprises a material that resorbs in-situ; the olfactory device comprises an aerosol spray configured to be applied as a film configured to cover at least a portion of an olfactory mucosa; the olfactory device comprises a liquid configured to be applied as a film configured to cover at least a portion of an olfactory mucosa; the olfactory device comprises a gel configured to be applied as a film configured to cover at least a portion of an olfactory mucosa; the olfactory device comprises closed-cell foam configured to cover at least a portion of an olfactory mucosa; the olfactory device comprises an expandable stent structure and a membrane configured to cover at least a portion of an olfactory mucosa; the olfactory device is delivered via a elongate member inserted into the nasal cavity; and the olfactory device is delivered via an elongate member inserted into the nasal cavity, and wherein, during insertion a distal curvature of the elongate member is advanced along an anterior wall of the nasal cavity maintaining intimate contact therewith until a distal end of the elongate member encounters a significant increase in resistance, indicating the distal end thereof is abutting a posterior-superior angle of the nasal cavity.

In another embodiment, a method of treating a patient with an olfactory-triggered condition may include diagnosing the patient's olfactory-triggered condition. In response to the diagnosis, the method may also include placing an olfactory device in the patient's nasal vestibule, the olfactory device defining an opening to permit free breathing therethrough when placed in the nasal vestibule, the olfactory device emanating a benign odorant that masks a culprit odorant to mitigate the olfactory-triggered condition.

In another embodiment, a method of treating a patient with an olfactory-triggered condition may include diagnosing the patient's olfactory-triggered condition. In response to the diagnosis, the method may further include placing a baffle olfactory device in the patient's nasal cavity inferior to the patient's olfactory area, the baffle olfactory device re-directing airflow through the nasal cavity away from the olfactory area to mitigate exposure of the olfactory area to a triggering odorant thereby mitigating the olfactory-triggered condition.

In another embodiment, a method of inhibiting exposure of a person's olfactory area to harmful or irritable airborne matter by placing a barrier over the person's left and right olfactory mucosa.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIGS. 1-3 are schematic illustrations of the nasal cavity anatomy;

FIGS. 4A-4D schematically illustrate an embodiment of an olfactory device including a film or coating, in accordance with the present disclosure;

FIGS. 5A-5C schematically illustrate alternative embodiments of devices configured for delivering one or more of the various olfactory devices disclosed herein;

FIGS. 6A-6D schematically illustrate an alternative embodiment of an olfactory device including a rod-like configuration, in accordance with a further embodiment;

FIGS. 7A-7C schematically illustrate exemplary delivery devices and methods for delivering an olfactory device according to the present disclosure;

FIGS. 8A-8D schematically illustrate another alternative embodiment of an olfactory device including a rectangular ellipsoid configuration;

FIGS. 9A-9D schematically illustrate yet another alternative embodiment of an olfactory device incorporating an anchoring or stabilizing member;

FIGS. 10A-10D schematically illustrate another alternative embodiment of an olfactory device in an expandable configuration placed adjacent the olfactory area of a patient;

FIGS. 11A-11B schematically illustrate another alternative embodiment of an olfactory device in an expandable configuration placed in the nares inferiorly of olfactory area;

FIGS. 12A-12B schematically illustrate another alternative embodiment of an olfactory device in the form of a baffle that redirects airflow away from the olfactory area;

FIG. 13 illustrates a method of weight loss using an olfactory device;

FIG. 14 illustrates a method of reducing the likelihood of morning sickness using an olfactory device; and

FIG. 15 illustrates a method of reducing the likelihood of migraine attack using an olfactory device.

### DETAILED DESCRIPTION

### Overview

The present disclosure provides several embodiments of olfactory devices and methods for partially or completely blocking, masking, reducing, or otherwise affecting olfactory input to, among other things, mitigate adverse responses thereto. In some embodiments, the olfactory device may provide a partial or complete barrier between the olfactory area and environmental odors, toxins, and other undesirable airborne matter. In other embodiments, the olfactory device may provide an alternative odor (e.g., pleasant odor) to overwhelm and thereby mask a malodor and/or neutralize an effect or perception of the malodor. In other embodiments, the olfactory device may re-direct respiratory airflow to avoid or diminish exposure to the olfactory area.

In some embodiments, one or more of the olfactory devices disclosed herein may be implanted in the nasal cavity to form a physical barrier between the olfactory nervous system and environmental odors, toxins, and other undesirable airborne matter. The devices may be configured to be temporarily effective and avoid permanent loss of olfactory function. For example, the devices may be configured to be effective for hours, days, weeks, months, or any predetermined length of time, after which they may be reapplied if desired. The devices may be configured to be delivered by a trained health professional (physician or nurse, e.g.) or by the patient. That is to say, in some embodiments, one or more of the embodiments described herein may be self-implanted or otherwise self-applied by a patient. The devices may be configured to be non-resorbable, resorbable, dissolvable, or degradable over time, or removed by a trained health professional or by the patient. The devices may be configured (size, shape and position) to reside at least partially, if not completely, in the olfactory area in the superior aspect of the nasal cavity where the olfactory mucosa and olfactory nerve endings reside. The devices are thus configured to avoid substantial interference with breathing and sinus drainage. In some embodiments, the devices may be formed of non-porous material and/or incorporate antibiotics to reduce the risk of infection, for example. Those of ordinary skill in the art will readily recognize that the devices may incorporate any suitable therapeutic agent. Further, in some embodiments, the devices disclosed herein may include one or more coatings comprising suitable therapeutic agents.

The olfactory devices described herein may be a solid, semi-solid, gel, liquid, or aerosol form. The olfactory devices may be formed of a non-resorbable material such as medical grade silicone, latex, polyurethane, latex-like synthetic materials including styrene-butadiene rubber, acrylonitrile butadiene styrene, acrylic polymers and polyvinyl acetate, cellulose and derivatives (unmodified cellulose, cotton, oxidized cellulose, viscose (Rayon), carboxy-methyl-cellulose (CMC), and alkyl and hydroxyalkyl cellulose), alginate, calcium alginate, polyacrylic acid, or polyvinyl alcohol (PVA), for example. The olfactory devices may be formed of a degradable or resorbable material such as biodegradable polyurethane, poly(lactic-co-glycolic acid) (PLGA), chitosan, hyaluronic acid, gum, gelatin, polyethylene glycol, or polyethylene oxide, for example. Other possibilities include surgical sealants formed of fibrin glue, platelet gel, polyethylene glycol or polyethylene glycol gel spray, microporous polysaccharide hemispheres (MPH), bovine serum albumin, gluteraldehyde, polyvinylpyrrolidone, collagen, cyanoacrylate or alginate, for example.

These resorbable or non-resorbable materials may be mounted on a frame or scaffolding and/or may contain hooks, anchors, or other means of attachment to tissue which may be metallic (nickel titanium (nitinol), stainless steel, tantalum, L-605, MP35-N, cobalt chromium, for example) or resorbable or non-resorbable polymeric (typically consisting of the materials listed above).

A number of different applications are envisioned. For example, the olfactory devices and methods described herein may be used in clinical settings to: modify odorant-triggered over-eating behavior to assist in excess weight loss; reduce the likelihood or severity of odorant-triggered morning sickness; or reduce the likelihood or severity of odorant-triggered migraine headaches. Alternatively or in addition, the olfactory devices and methods described herein may be used to provide a barrier from environmental malodors, toxins or the like in industrial, occupational or military settings. Some of these clinical, occupational, industrial and military applications are described in more detail below.

Obesity is a worldwide health problem that has thus far been elusive to a broadly successful solution. The devices disclosed herein may be used to prevent the user from smelling food, thus limiting their enjoyment and positive feedback from eating food, and ultimately help them lose weight via reduced caloric intake. Alternatively, the devices disclosed herein may be used as a part of a diet plan to assist in reducing excess weight and maintaining excess weight loss.

Furthermore, morning sickness affects over 75% of pregnant women, and over 50% of those experiencing morning sickness have nausea and/or vomiting triggered by odorants. The devices disclosed herein may be used to reduce or block the sense of smell in pregnant women, thereby decreasing the likelihood that an odorant will trigger morning sickness. Those of ordinary skill will readily recognize that the described devices and methods also may be used to mitigate nausea in individuals other than pregnant women.

Migraine headaches affect 12% of adults, and about 36% of migraine sufferers have headaches that are triggered by smell, with hyper-acuity of smell being a common complaint between migraine attacks. The methods and devices disclosed herein may be used to reduce or block the sense of smell in migraine sufferers, thereby decreasing the likelihood that an odorant will trigger a migraine attack and/or cause discomfort due to olfactory hyper-acuity.

Environmental malodors may be common in some occupational and industrial settings. The devices disclosed herein may be used to reduce or block exposure of the olfactory system to such environmental malodors.

Environmental toxins may be common in some occupational or industrial settings, and chemical weapons may be a threat in some military settings. Because the olfactory system provides a direct link to the brain, such toxins and chemical weapons can have serious detrimental effects on those exposed. Accordingly, the devices disclosed herein may be used to provide a barrier between the olfactory system and such toxins and chemical weapons, thus reducing the associated health risks.

In addition, the therapeutic effect of certain medicaments may be enhanced by, e.g., rapid absorption into a patient's system. Accordingly, the devices and methods disclosed herein may be used to deliver medicaments to a patient through one or more nasal passages.

### Exemplary Embodiments

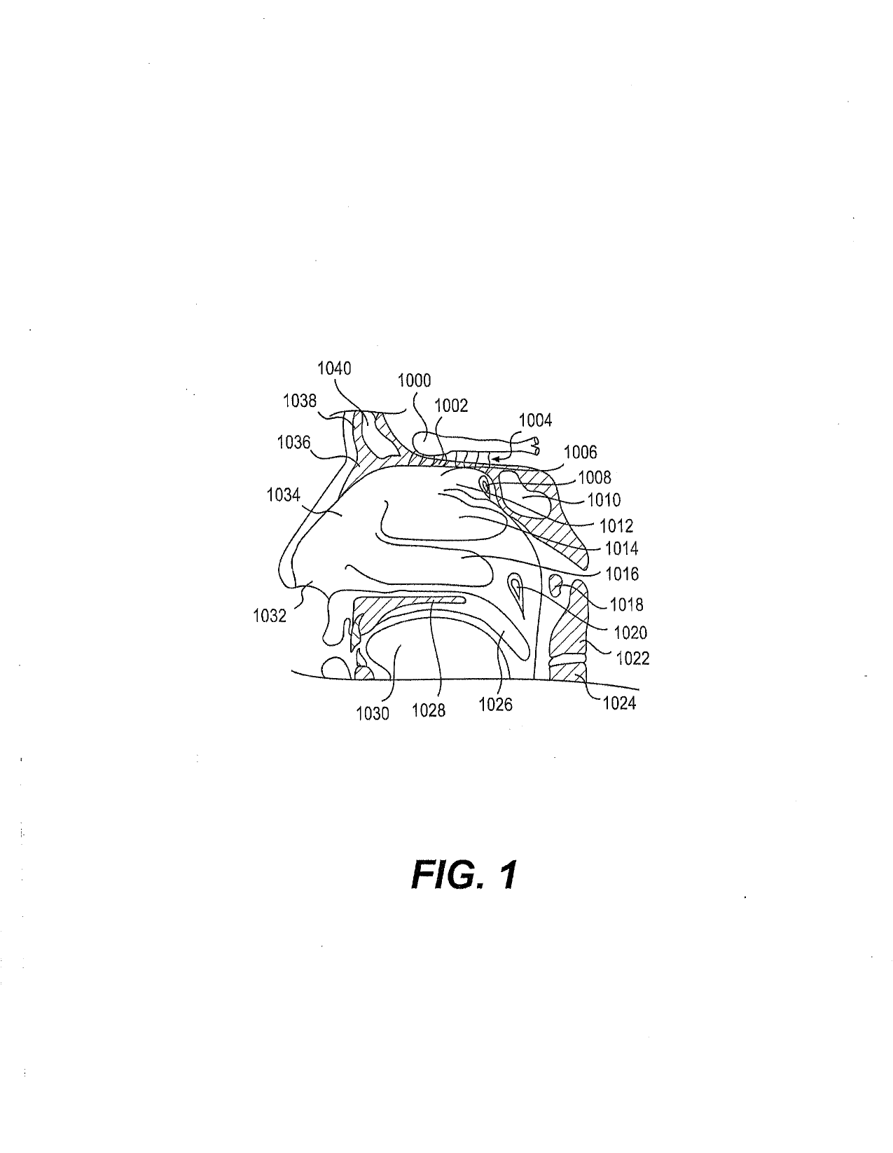

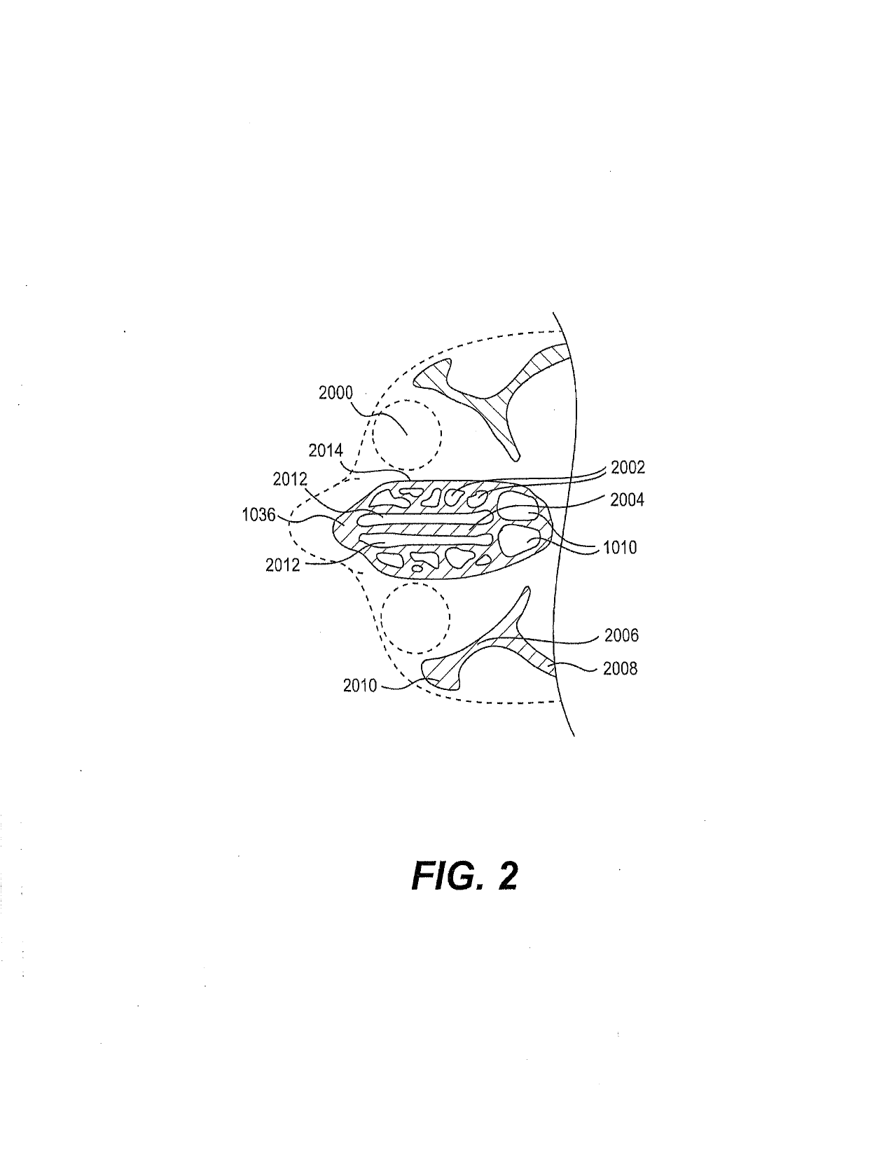

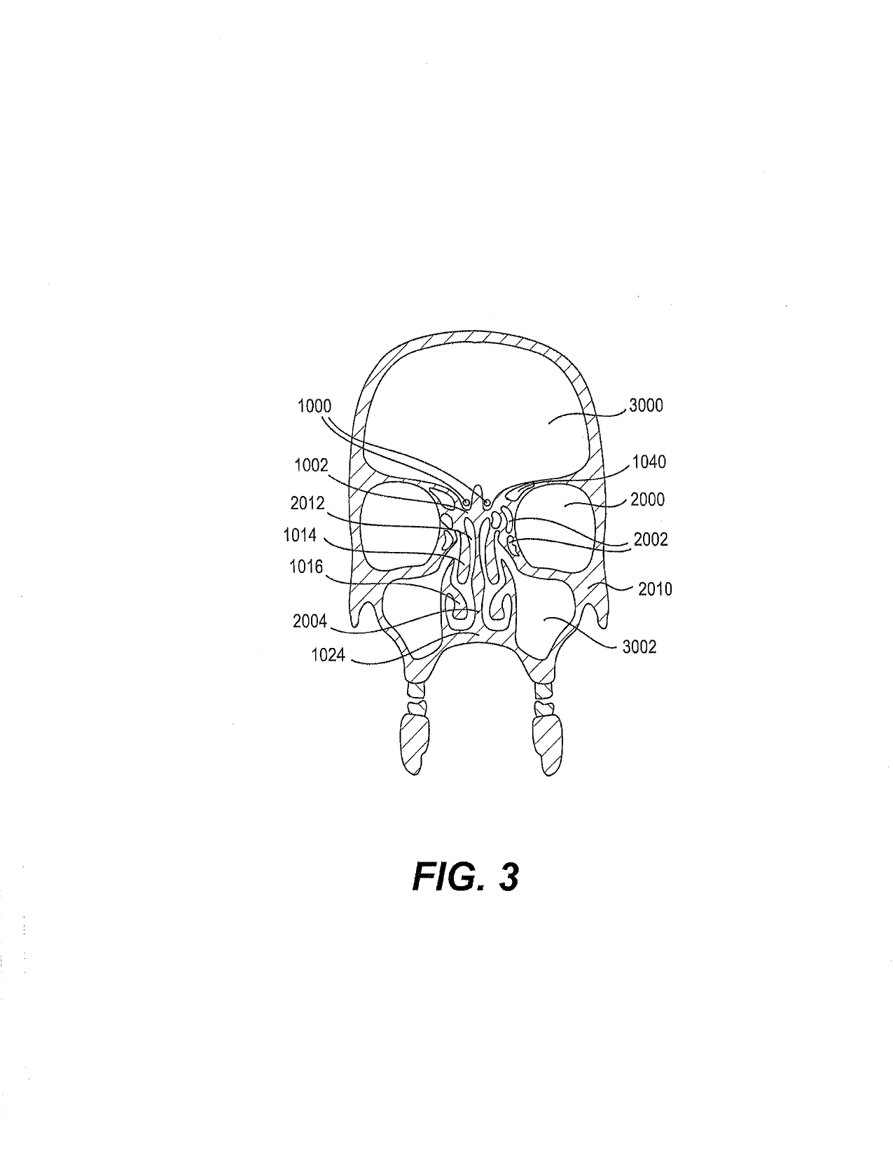

With reference to FIGS. 1-3, schematic illustrations of the anatomy of the human nasal cavity 2012 are shown. FIG. 1 is a sagittal section, FIG. 2 is a horizontal section, and FIG. 3 is a coronal section. (In each of FIGS. 1-3, sectioned boney structures are shown by cross-hatching.)

As best seen in FIG. 1, the olfactory bulb 1000 is located superiorly to the cribriform plate 1002, with olfactory nerves 1004 extending through the cribriform plate 1002 to the olfactory mucosa 1006. The olfactory mucosa 1006 resides in the superior portion of the nasal cavity 2012, generally on the superior nasal turbinate 1012, and extends inferiorly along the lateral walls 1034 and septal wall 2004 to the superior portion of the middle nasal turbinate 1014. Odorants exposed to the olfactory mucosa 1006 are thus sensed by the olfactory nerves 1004 and transmitted to the brain 3000 via the olfactory bulbs 1000.

The olfactory devices described herein may be temporarily placed partially or completely over the olfactory mucosa 1006 to provide a complete or partial barrier to the olfactory system from environmental odorants, malodors, toxins and other harmful or irritating airborne matter. The devices may be placed unilaterally or bilaterally in the nasal cavities 2012 and may be configured to avoid blocking the openings (e.g., the openings 1008 of the sphenoidal sinus 1010) to the sinuses, such as the sphenoid sinus 1010. Because respiratory airflow primarily occurs inferiorly to the olfactory area, the devices do not substantially interfere with normal nasal respiration.

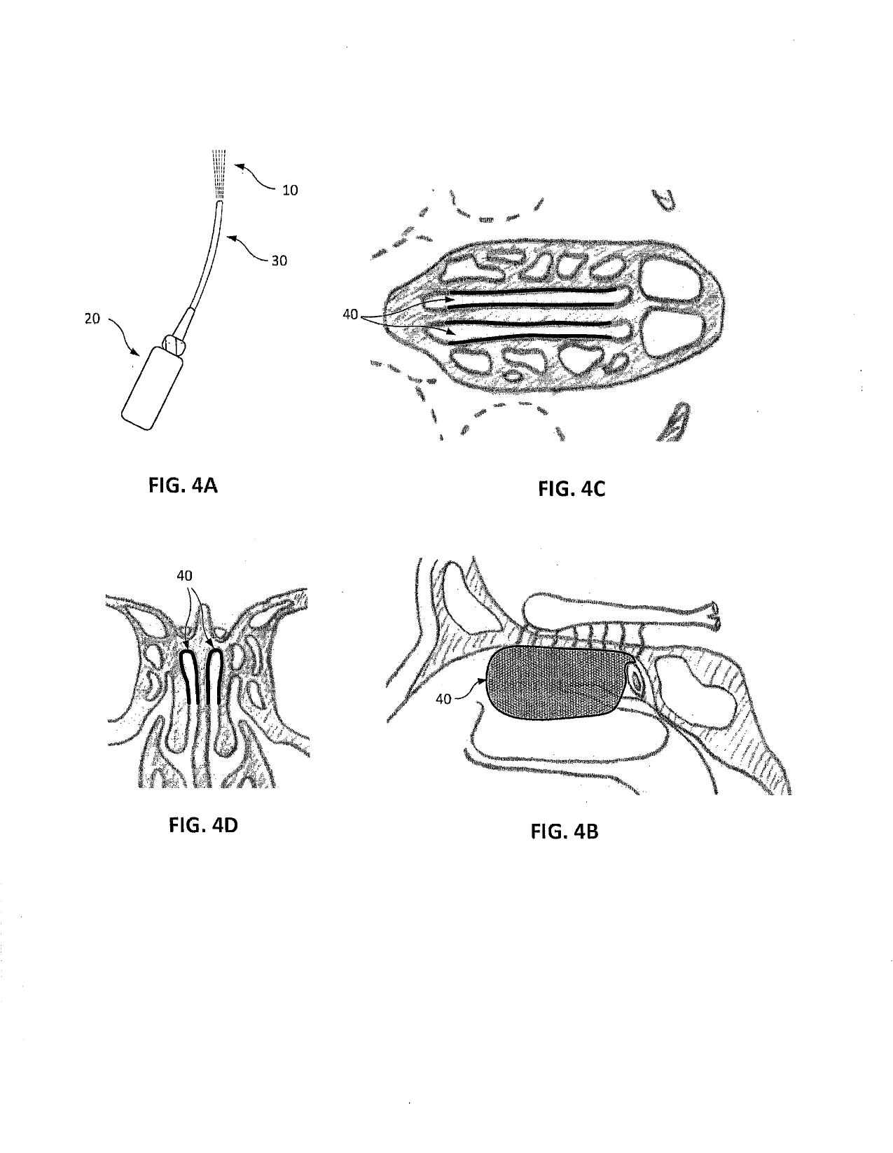

With reference to FIGS. 4A-4D, an embodiment of an olfactory device in the form of a film or coating 40 is schematically illustrated. Those of ordinary skill in the art will recognize that the film or coating may include any suitable thickness appropriate for a particular application and/or patient. For example, the film or coating 40 may be relatively thin. In other embodiments, however, the applied film or coating 40 may be relatively thicker. The film or coating 40 may be applied in the form of an aerosol, liquid or gel 10, for example, by a nasal spray device 20 as shown in FIG. 4A. In addition, the film or coating 40 may be inhaled as a powder configured to interact with nasal mucus to form a gelatinous matrix that adheres to surfaces within the nasal cavities 2012. In further embodiments, the inhaled powder may be gelatinized by an incorporated gelatinization agent configured to activate upon exposure to, e.g., atmospheric air and/or body temperature or chemistry. Even further, the inhaled powder may be gelatinized by the application of an additional gelatinization agent, including, but not limited to, water. To selectively access the superior portion of the nasal cavity 2012, the spray device 20 (FIG. 4A) may incorporate a flexible catheter or cannula 30. The film or coating 40 may be applied to the olfactory mucosa 1006, covering the apexes of the nasal cavities 2012 as seen in FIGS. 4B and 4D, and covering the lateral 1034 and septal walls 2004 to the superior portion of the middle nasal turbinate 1014 as seen in FIGS. 4C and 4D. The film or coating 40 may comprise a non-resorbable, resorbable, dissolvable or degradable material. Examples include gel, liquid or aerosol suspensions of hyaluronic acid, polysaccharide, cellulose, and collagen. The material may incorporate an adhesive material to facilitate bonding to the mucosa 1006. Optionally, the sinus openings (e.g., sphenoid sinus openings) may be occluded prior to delivery of the film or coating 40 using a cotton swab, for example.

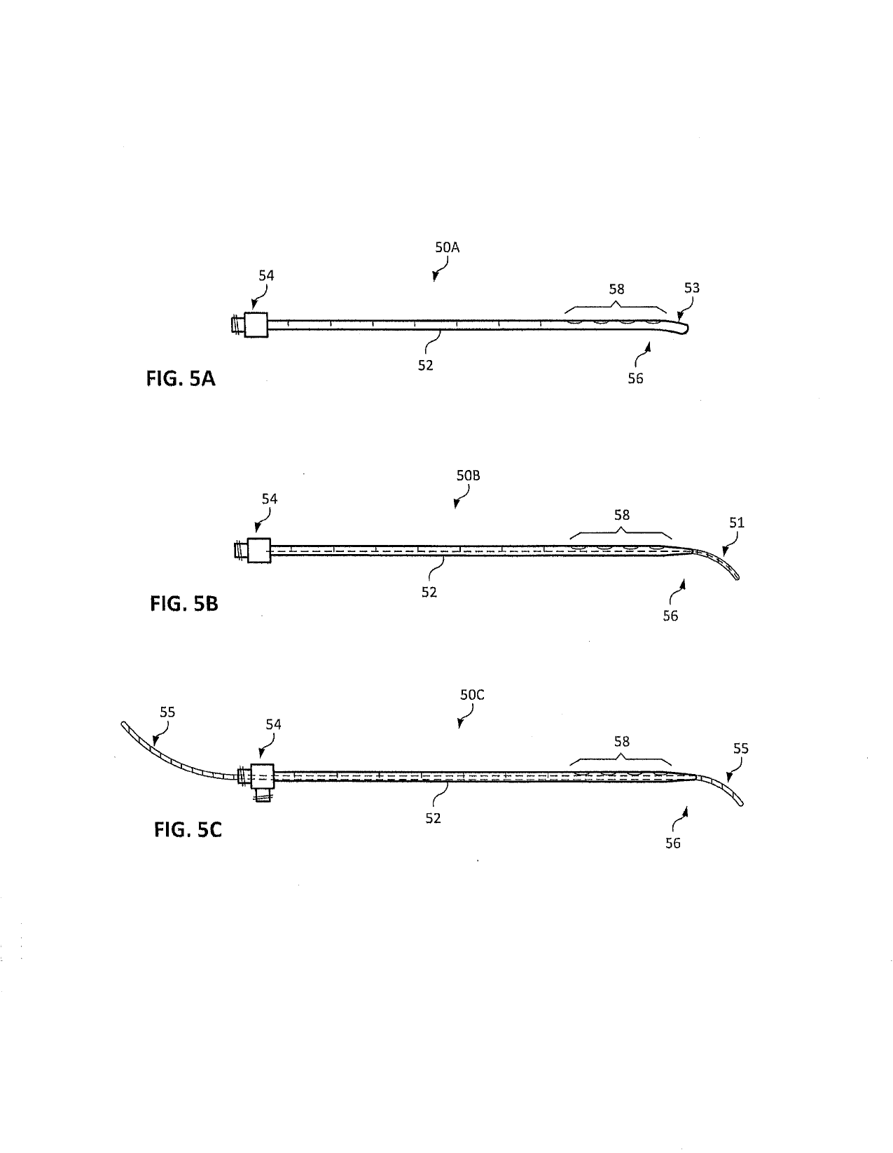

With reference to FIGS. 5A-5C, alternative embodiments of delivery devices are shown schematically. As illustrated, these delivery devices are configured to deliver an aerosol, liquid or gel, as described with reference to FIGS. 4A-4D, locally and limited to the olfactory area. The devices may be also configured to deliver a powder. Slightly modified configurations may also be used to deliver solid and semi-solid devices described hereinafter. In addition, these delivery devices may be used to locally deliver drugs to the olfactory area such as a calcium channel blocker (Diltiazem) which has been shown to block signal transport in the olfactory nerves.

In FIG. 5A, a catheter 50A includes a tubular shaft 52 extending from a proximal connector 54 to a distal section 56. The proximal connector 54 includes an infusion port for connection to a liquid or aerosol bottle (not shown). An infusion lumen in the catheter 50 provides for fluid communication from the infusion port in the proximal connector 54 to one or multiple distal side ports 58, and the infusion lumen may terminate proximal to the distal end of the catheter 50 such that fluid exits the side ports 58 only. The catheter 50A also may include one or more lumens in addition to the infusion lumen. The additional lumen(s) may be configured to advance light sources and/or imaging equipment into a patient's nasal cavities 2012. In addition, the additional lumen(s) may be configured to deliver, e.g., irrigation to clean or flush a patient's nasal cavity 2012 prior to the delivery of the devices disclosed herein.

A curved portion 53 may be provided adjacent the distal end of the catheter 50A to facilitate blinded or endoscopically guided insertion of the catheter 50A along the anterior wall of the nasal cavity 2012 to the apex of the nasal cavity 2012. Such curvature 53 may be less than 90 degrees to prevent hanging up on the nasal turbinates during insertion. The catheter 50A may have an outside diameter of approximately 2.0 mm or less to fit within the superior portion of the nasal cavity 2012 which is typically less than 3.0 mm wide, and generally inaccessible by endoscopy. The catheter 50A may have a length of approximately 10 cm to extend from the nares to the posterior-superior angle following the anterior wall of the nasal cavity 2012, and may include incrementally graduated markers as shown to determine insertion distance.

During insertion, the distal curvature 53 may be advanced along the anterior wall of the nasal cavity 2012 maintaining intimate contact therewith until the distal end of the catheter 50A encounters a significant increase in resistance, indicating the distal tip thereof is abutting the posterior-superior angle of the nasal cavity 2012. Also during insertion, the distal curvature 53, which follows the natural curvature of the anterior wall of the nasal cavity 2012, may be positioned with the concave side facing inferiorly such that the side ports 58 are naturally facing superiorly and the delivery of fluids will be directed toward the olfactory mucosa. Insertion of the catheter 50A beyond the increase in resistance or beyond 10 cm may result in the delivery of fluids too posteriorly, missing the olfactory area. Typically, the desirable insertion distance may be approximately 5 cm-8 cm.

To facilitate atraumatic insertion and tactile sensation of the correct insertion distance, the catheter shaft 52 may have a graduated flexibility along its length, with the distal portion thereof being more flexible than the proximal portion thereof. This may be accomplished, for example, by providing a polymeric shaft 52 with a graduated durometer, a graduated wall thickness, an embedded wire braid in the proximal section, an embedded wire coil in the distal section, or a combination thereof.

In FIG. 5B, catheter 50B is essentially the same as catheter 50A shown in FIG. 5A except that a fixed wire 51 is used to provide for graduated flexibility, atraumatic insertion, curvature, and tactile sensation of the correct insertion distance. The fixed wire 51 may include a core wire extending through the shaft 52 and connected to the proximal connector 54. The fixed wire 51 also includes a coiled flexible distal tip onto which the distal end of the shaft 52 is tapered and sealed. The coiled distal tip may be straight or have a curved configuration, with such curvature being less than approximately 90 degrees to prevent hanging up on the nasal turbinates during insertion.

In FIG. 5C, catheter 50C is essentially the same as catheter 50A shown in FIG. 5A except that a free wire 55 is used to provide for graduated flexibility, atraumatic insertion, curvature, and tactile sensation of the correct insertion distance. The free wire 55 may include a core wire and a coiled flexible distal tip. The coiled distal tip may be straight or have a curved configuration, with such curvature being less than approximately 90 degrees to prevent hanging up on the nasal turbinates during insertion. Alternatively, the distal coil can be curved but selectively straightened when tensile and/or compressive forces are placed on the wire. Whereas in the embodiment of FIG. 5B, the catheter 50B is inserted at the same time as the fixed wire 51, the embodiment of FIG. 5C allows the free wire 55 to be inserted first or at the same time as the catheter 50C. In this configuration, the shaft 52 of the catheter 50C may include an additional lumen separate from the infusion lumen to accommodate the free wire 55, and a separate infusion port may be provided in the proximal connector 54. The length of the free wire 55 may be approximately twice the length of the catheter 50C to accommodate advancement and removal of the catheter 50C thereon while the free wire 55 resides in the nasal cavity. Catheter 50C may be provided with a mechanism for fixing a position of free wire 55 relative to shaft 52.

All wires, coils, and catheters in this application may be coated with lubricious materials to aid in their insertion. Examples of suitable lubricious coatings include fluoropolymers (including, but not limited to, PTFE, FEP, PEEK, and others), silicones, hydrophilic coatings, and other substances that when applied will reduce the coefficient of friction between materials that are in contact with each other or in contact with the body. The wires, coils, and catheters may be also coated with suitable anesthetics to reduce any discomfort caused during insertion.

All wires, coils, and catheters in the application may be configured to be steerable and/or torquable. Torquability can be accomplished by embedding braid into the polymer of a catheter or by configuring a wire or coil so that it can be rotated. The curved tip of a catheter can be deflected or steered by utilizing a coaxial slideable tube to engage and change the curvature of the curve or through changing the tension in wires that are connected to the curved tip and potentially embedded within the wall or within the lumen of the catheter.

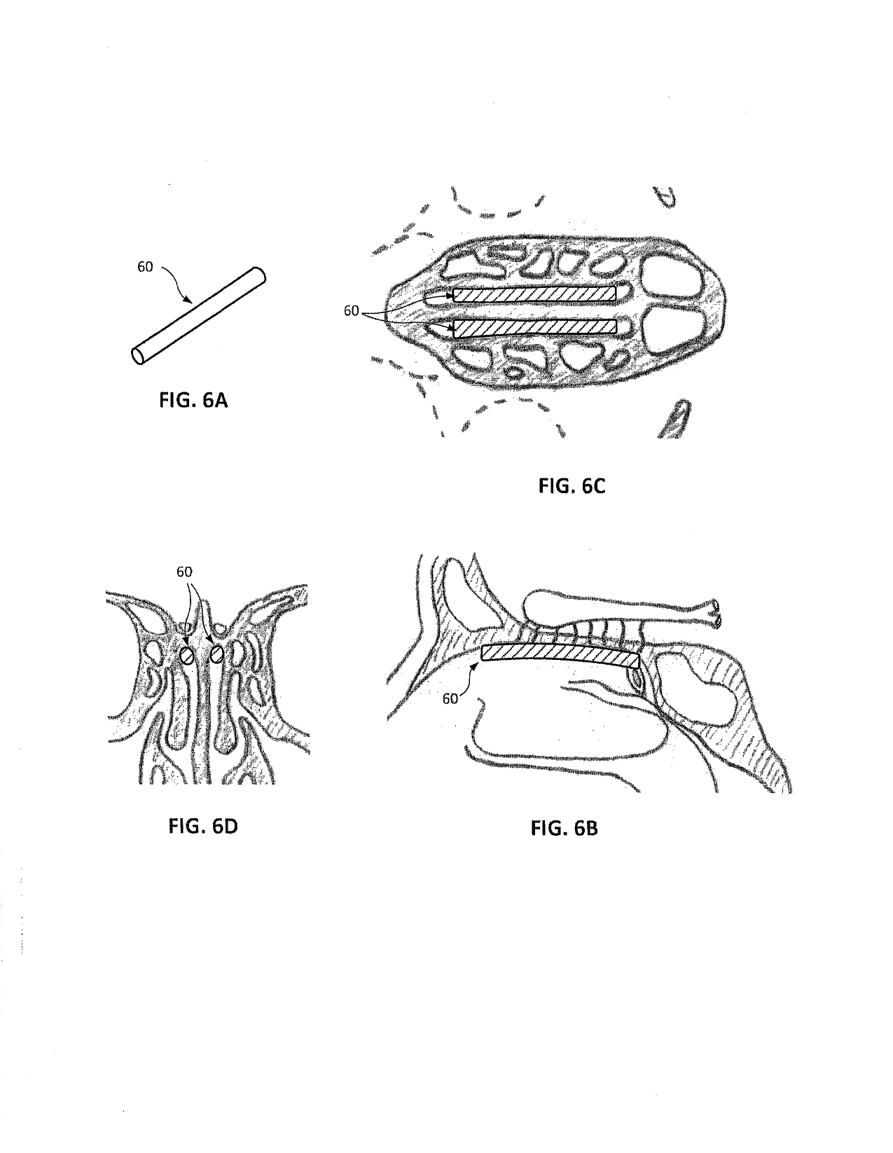

With reference to FIGS. 6A-6D, another embodiment of an olfactory device in the form of an expandable rod 60 is schematically illustrated. Solely for the purposes of discussion, rod 60 is described and illustrated as including a substantially cylindrical configuration. However, those of ordinary skill in the art will understand that rod 60 may include any suitable configuration. As best seen in FIG. 6A, the cylindrical rod 60 may comprise a solid or semi-solid (e.g., closed-cell foam) material, and may be made of a resorbable, degradable or dissolvable material such as cross-linked hyaluronic acid, cellulose, polysaccharides, collagen, silicone, PTFE or PEG, for example. The cylindrical rod 60 may have a non-porous surface to avoid microbial in-growth, and may incorporate an antibiotic agent to reduce the likelihood of infection. The cylindrical rod 60 also may include any suitable coating, including coatings of adhesives or suitable therapeutic agents. The cylindrical rod 60 may be inserted trans-nasally into each nasal cavity 2012 to cover the olfactory mucosa 1006 adjacent the apexes of the nasal cavities 2012 as seen in FIGS. 6B and 6D. The cylindrical rod 60 may be positioned to cover the olfactory area at the superior portions of the lateral 1034 and septal 2004 walls as seen in FIGS. 6C and 6D. The nasal cavity 2012 in the olfactory area typically has a lateral dimension of approximately 1-2 mm and an anterior-posterior dimension of about approximately 2-4 cm. Thus, by way of example, the rod 60 may have a diameter of approximately 1.0 mm-3.0 mm and a length of approximately 2 cm-5 cm to snuggly fit in the nasal cavity in the olfactory area.

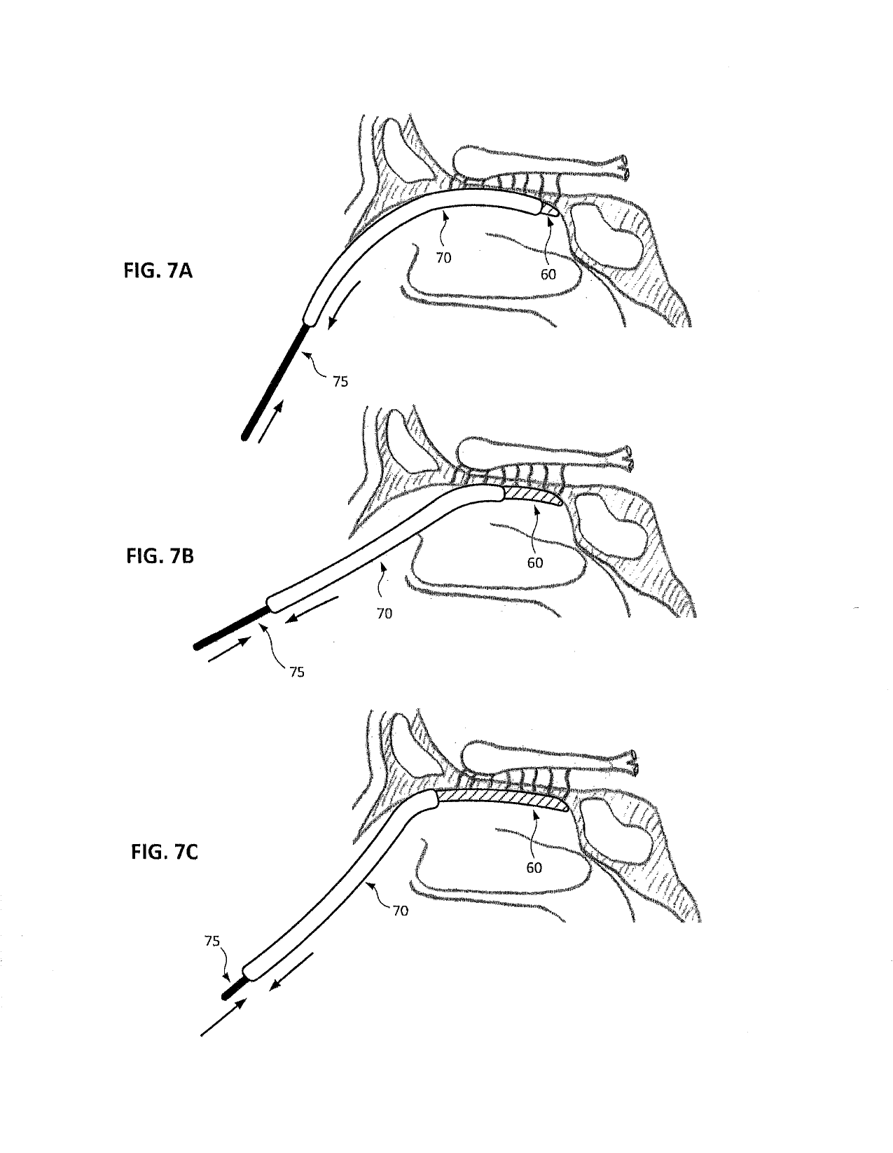

As seen in FIGS. 7A-7C, the cylindrical rod 60 may be configured to be elastically expandable with two configurations: (1) a smaller profile delivery configuration to facilitate delivery using a cannula or catheter 70 inserted into the nasal cavity 2012; and (2) a larger profile deployed configuration when pushed out of catheter 70 by push rod 75. The transition from a relatively smaller delivery configuration to a relatively larger deployed configuration may be accomplished via elastic deformation or hydrophilic absorption, for example. In further embodiments, rod 60 may be self-expandable. As discussed in greater detail below, embodiments of rod 60 may be mechanically expandable. In yet further embodiments, rod 60 may be expanded by inflation. In embodiments where rod 60 is expanded via inflation, rod 60 may include an internal bladder (not shown) operably coupled to an inflation port (not shown), which in turn may be operably coupled to an inflation source (not shown) via catheter 70. The larger profile deployed configuration facilitates secure placement of the device 60 by frictional engagement with the lateral 1034 walls and septum 2004 of the nasal cavity.

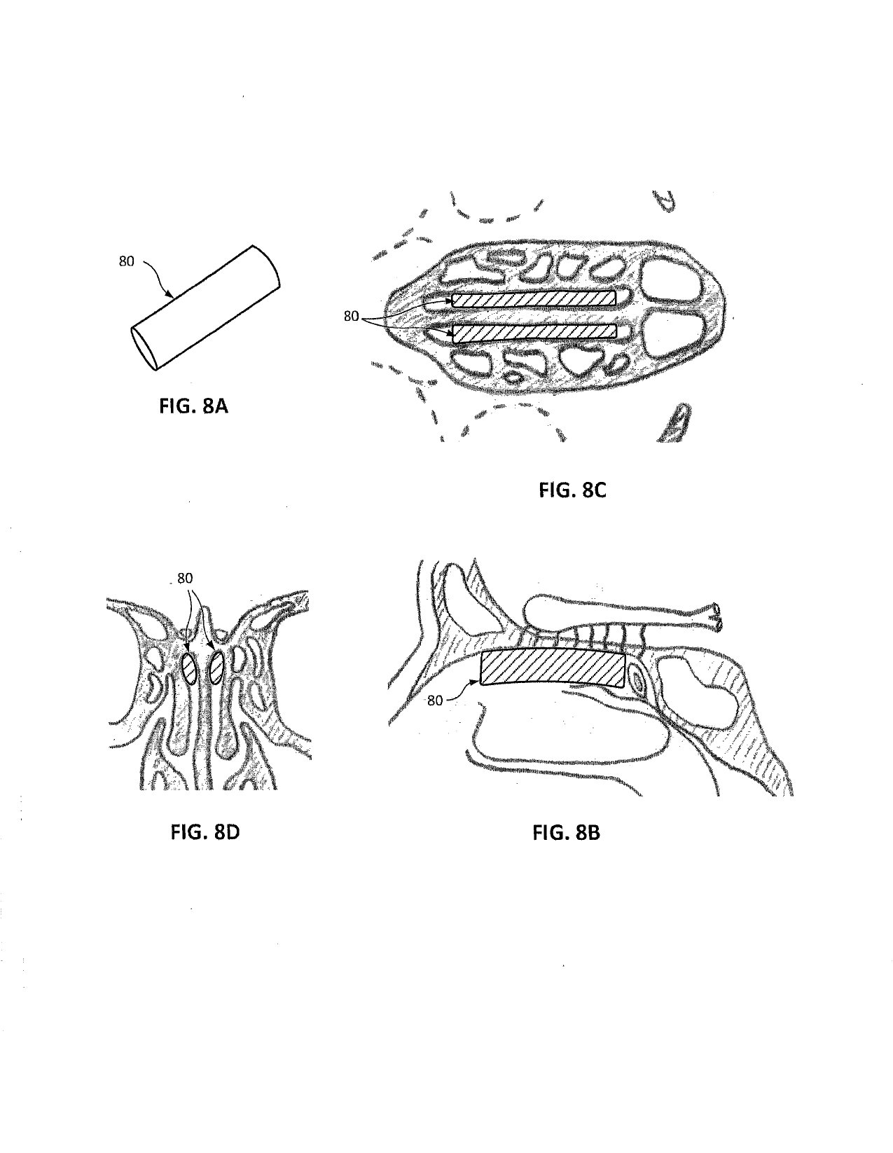

With reference to FIGS. 8A-8D, yet another embodiment of an olfactory device in the form of an ellipsoid 80 is schematically illustrated. Solely for purposes of discussion, ellipsoid 80 is described and illustrated with a rectangular configuration. However, those of ordinary skill in the art will readily recognize that ellipsoid 80 may have any suitable configuration. Rectangular ellipsoid 80 may be made of the same material and delivered in a similar manner as cylindrical rod 60. However, in this embodiment, the rectangular ellipsoid 80 may be configured to extend more inferiorly to cover the lateral wall 1034 and septal 2024 walls to the superior portion of the middle nasal turbinate 1014 as seen in FIGS. 8B and 8D. By way of example, the ellipsoid 80 may have a width of approximately 1.0 mm-3.0 mm, a length of approximately 2 cm-5 cm, and a height of approximately 0.75-1.25 cm to snuggly fit in the nasal cavity 2012 in the olfactory area. Ellipsoid 80 may include one or more of the features described in conjunction with rod 60. For example, the rectangular ellipsoid 80 may be configured to be expandable with two configurations similar to cylindrical rod 60, and similarly delivered using a catheter 70 and a push rod 75 as shown in FIGS. 7A-7C.

Embodiments of the olfactory devices disclosed herein may be shaped like a cylindrical rod 60 as shown in FIGS. 6A-6D, a rectangular ellipsoid 80 as shown in FIGS. 8A-8D, or any other suitable shape to anatomically conform to the shape of the superior apex of the nasal cavity 2012 and cover all or a portion of the olfactory mucosa 1006 to achieve the desired effect or decreasing or blocking exposure of the olfactory area to odorants or the like.

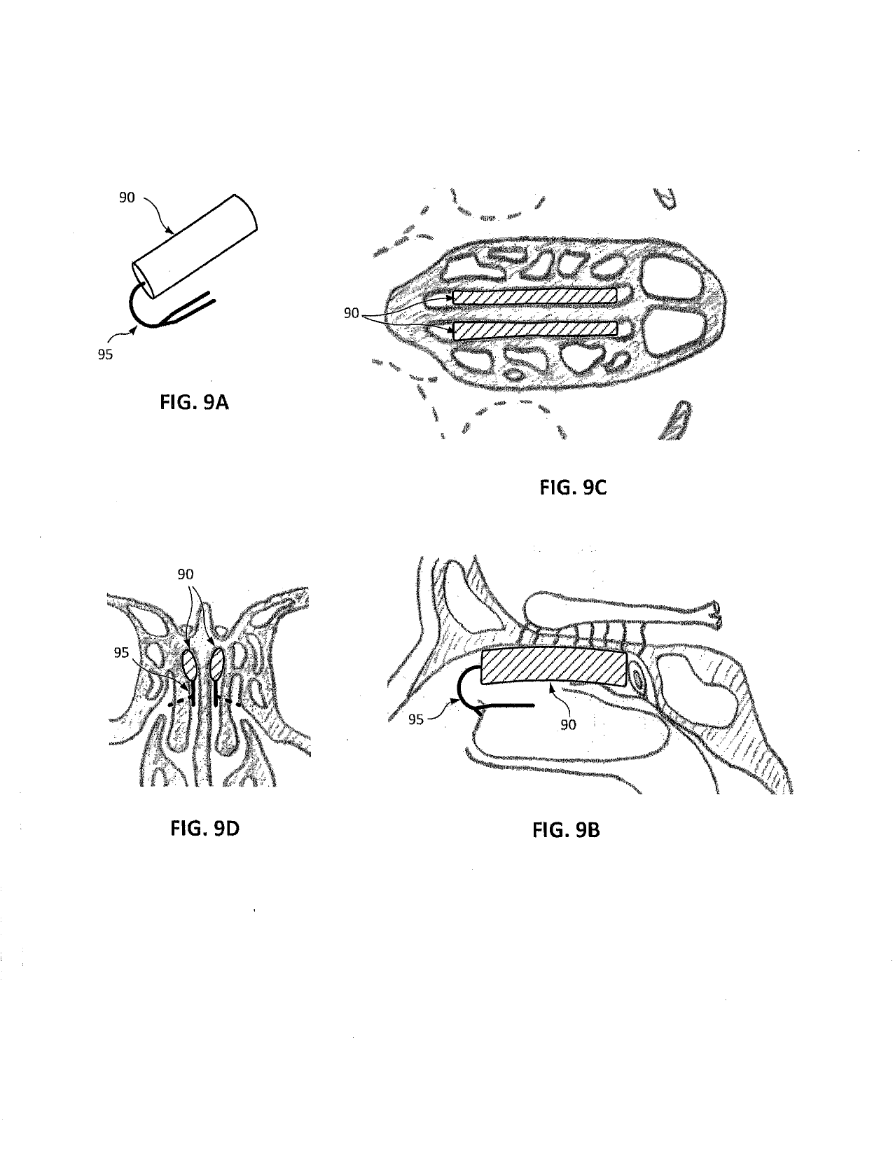

The olfactory device may be secured in place by adhesion as with the film or coating 40 shown in FIGS. 4A-4D, by friction as with the devices 60 and 80 shown in FIGS. 6A-6D and 8A-8D, respectively, and/or by utilizing a stabilizing member that anchors to an anatomical feature in the nasal cavity 2012. For example, with reference to FIGS. 9A-9D, an olfactory device 90 may include a stabilizing member 85 that clips to the middle turbinate 1014. The olfactory device 90 may be made of the same material, configured in the same size, shape and position, and delivered in a similar manner as rectangular ellipsoid 80. Stabilizing member 85 may comprise a wire form and may be made of a metal or polymeric material. In one embodiment, stabilizing member may have first and second extensions defining a cavity therebetween. The cavity may be configured to engage a portion of the middle turbinate.

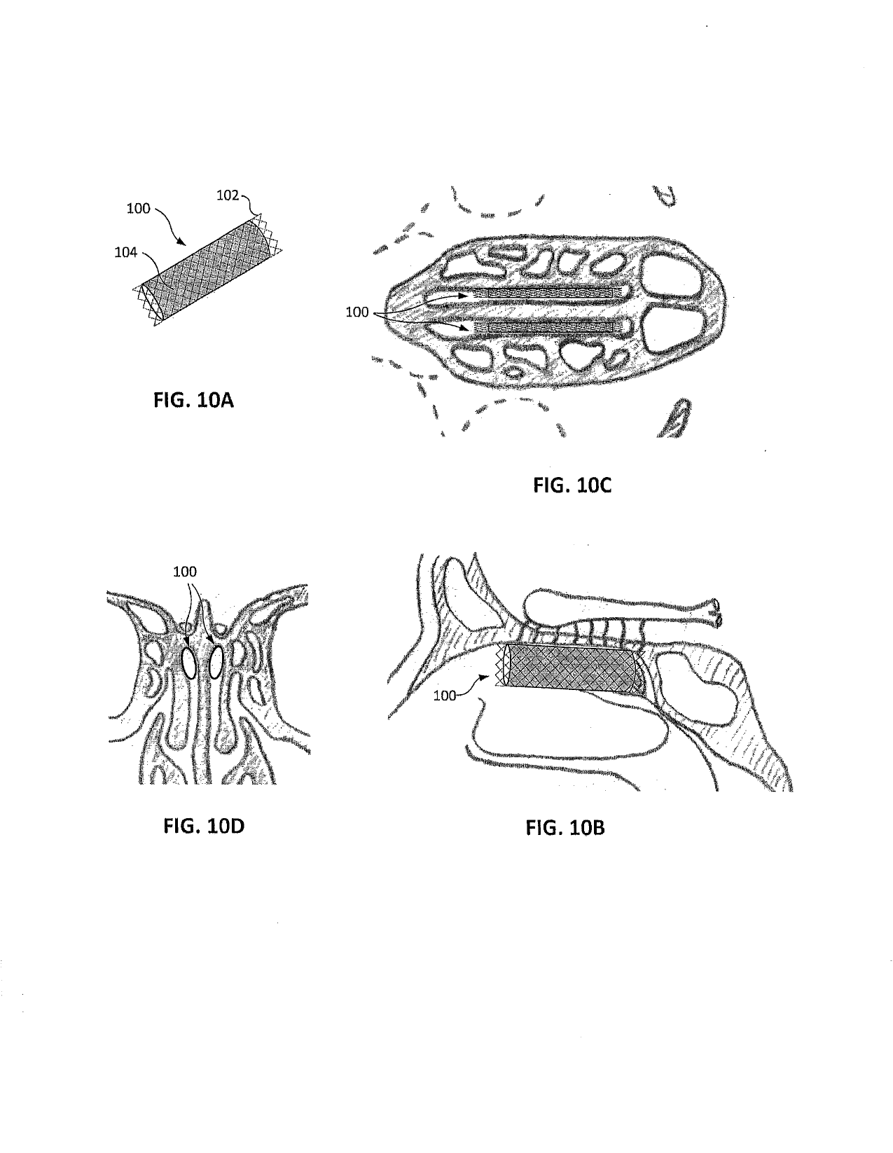

With reference to FIGS. 10A-10D, another embodiment of an olfactory device in the form of an expandable and covered stent 100 is schematically illustrated. As best seen in FIG. 10A, the covered stent 100 may comprise an elastically expandable polymeric or wire mesh structure 102 covered at least partially by a membrane 104. Membrane 104 may comprise a solid or semi-solid (e.g., closed-cell foam) material, and may be made of a non-resorbable, resorbable, degradable or dissolvable material such as cross-linked hyaluronic acid, cellulose, polysaccharide, collagen, silicone, PTFE or PEG, for example. The covered stent 100 may be inserted trans-nasally into each nasal cavity 2012 to cover the olfactory mucosa 1006 adjacent the apexes of the nasal cavities 2012 as seen in FIGS. 10B and 10D. The covered stent 100 may be positioned to cover the olfactory area at the superior portions of the lateral wall 1034 and walls of the septum 2004, as seen in FIGS. 10C and 10D.

By way of example, the covered stent 100 may have a width of approximately 1.0 mm-3.0 mm, a length of approximately 2 cm-5 cm and a height of approximately 0.75-1.25 cm to snuggly fit in the nasal cavity 2012 in the olfactory area. The covered stent 100 may be configured to be expandable with two configurations similar to cylindrical rod 60, and similarly delivered using a catheter 70 and a push rod 75 as shown in FIGS. 7A-7C.

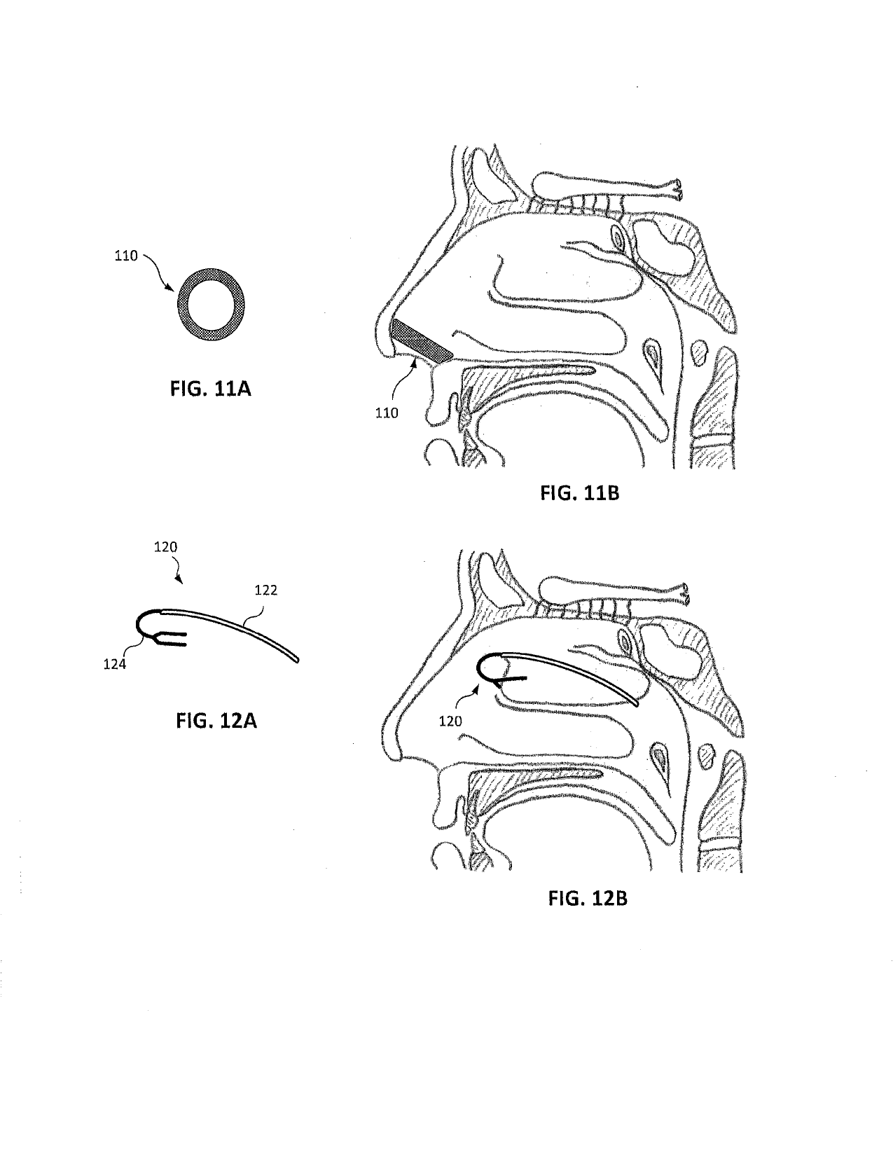

With reference to FIGS. 11A and 11B, another embodiment of an olfactory device 110 is shown schematically. As shown, the olfactory device 110 may be configured as an expandable cylinder. In some embodiments, the expandable cylinder may include a tapered profile. As shown, the cylinder may define a lumen therethrough. With reference to FIG. 11A, device 110 may include a substantially ring-like cross-sectional configuration. The device 110 may be configured to allow free respiratory airflow therethrough, and the tapered sides prevent unintended dislodgement from the nasal vestibule 1032. The device 110 may comprise a solid or semi-solid (e.g., closed-cell or open-cell foam) material, and may be made of a resorbable, degradable or dissolvable material such as cross-linked hyaluronic acid, cellulose, polysaccharide, collagen, silicone, PTFE or PEG, for example. The device 110 may be delivered to the nasal vestibule 1032 as shown in FIG. 11B by compressing the device 110 and manually inserting the same via the nares. In an implanted configuration, device 110 may be configured to longitudinally traverse the nares. Although FIG. 11B shows device 110 in a single nare, those of ordinary skill will recognize that device 110 may be implanted within both nares, as desired.

The device 110 is not intended to create a barrier between the olfactory area and environmental odors, but rather includes an impregnated chemical or mixture of chemicals that elute a dominating odorant, or reacts to specific odorants to neutralize their malodor. For example, the device 110 may incorporate a chemical that smells like a pleasant odor such as lemon, peppermint, etc., such that the pleasant odor is eluted at a higher intensity than the malodor, thus masking the malodor. Alternatively, the device 110 may incorporate an olfactory white mixture that elutes a broad band of odors of similar intensity, thus masking the malodor. An example of an olfactory white mixture is described by Weiss et al., Perceptual convergence of multi-component mixtures in olfaction implies an olfactory white, PNAS, 109:49; 19959-19964 (Dec. 4, 2012), the disclosure of which is incorporated herein by reference. Any of the olfactory devices described herein may be similarly configured to incorporate a chemical or mixture of chemicals that elute a dominating pleasant odorant or an olfactory white odorant, or react to specific malodorants to neutralize their malodor.

With reference to FIGS. 12A and 12B, another embodiment of an olfactory device 120 is shown schematically. Olfactory device 120 includes a baffle 122 and an optional stabilizing member 124. The baffle 122 may be configured similarly to rod 60 but placed inferior of the olfactory area at an anterior incline (posterior decline) to direct airflow away from the olfactory area in the nasal cavity. Optional stabilizing member 124 may secure the baffle 122 to the middle turbinate 1014. In this embodiment, the olfactory device 120 is not intended to create a barrier between the olfactory area and environmental odors, but rather re-direct respiratory airflow to avoid or diminish exposure to the olfactory area to odorants.

All olfactory devices described herein that are delivered in a smaller configuration and then expanded to a larger configuration may be made of materials that allow them to be self-expanding or alternatively be configured to be mechanically expanded. Self-expansion may involve removing a constraining member such as a sheath to allow the material to return to a desired geometry. Mechanical expansion may involve applying external forces to change the shape of the device. By way of example, external forces can be applied to the device by a balloon catheter where the balloon is inflated inside the device to expand it, or by a tether delivery system where the tether longitudinally compresses the ends of the device to expand the center of the device.

All olfactory devices described herein may include barbs, hooks, or other protruding geometries to engage the tissue and provide an anchoring force to prevent the implant from migrating.

All olfactory devices described herein may include hooks, loops, or other geometries which may be grasped to move or remove the device from its initial deployed location. These geometries could be engaged with a snare, catheter, wire, or similar device, for example.

As mentioned previously, the olfactory devices disclosed herein may have several clinical applications, which are described in more detail below.

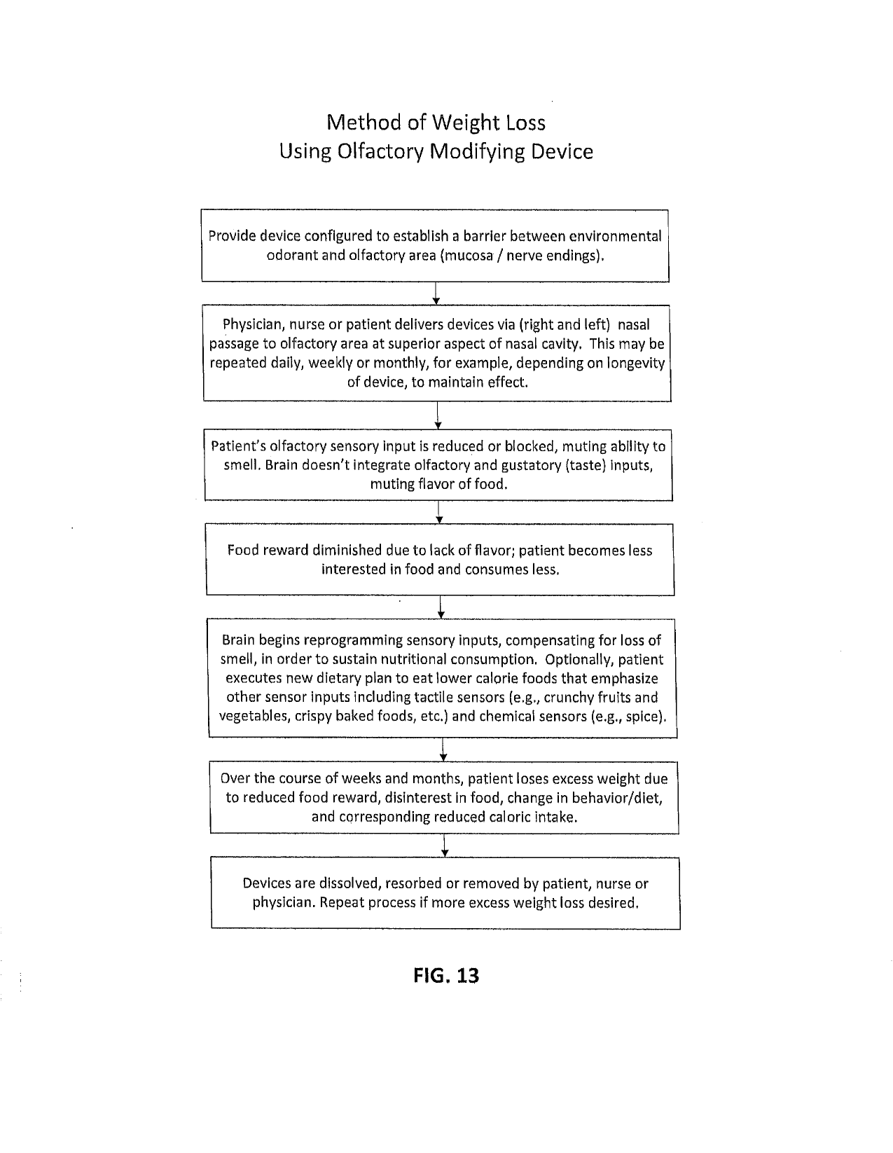

For example, and with reference to FIG. 13, the olfactory devices disclosed herein may be used in a method of facilitating excess weight loss. In this application, a physician, nurse or the patient delivers olfactory devices via the (right and left) nasal passages to the olfactory area adjacent the superior aspect of the nasal cavity 2012, for example. This may be repeated daily, weekly or monthly, for example, depending on the longevity of the olfactory device. The patient's olfactory senses are thus reduced or blocked, diminishing or muting the patient's ability to smell. Because of the lack of smell input, the patient's brain does not integrate taste input, thus diminishing or muting the flavor of food. The food reward is diminished due to lack of flavor, and the patient becomes less interested in food, ultimately consuming less food and calories. When the sense of smell is diminished or blocked, the patient's brain begins reprogramming sensory inputs, compensating for loss of smell, in order to sustain nutritional consumption. Thus, optionally, the patient may also execute a new dietary plan to eat lower calorie foods that emphasize other sensory inputs including tactile sensations (e.g., crunchy fruits and vegetables, crispy baked foods, etc.) and chemical sensations (e.g., spice). Over the course of weeks and months, e.g., the patient begins to lose excess weight due to reduced food reward, disinterest in food, changed behavior/diet, and corresponding reduced caloric intake. The device may be resorbed, dissolved or degraded, or removed by a physician, nurse or the patient after a pre-determined period of time or upon achieving a desired weight loss goal. The process may be repeated if more excess weight loss is desired.

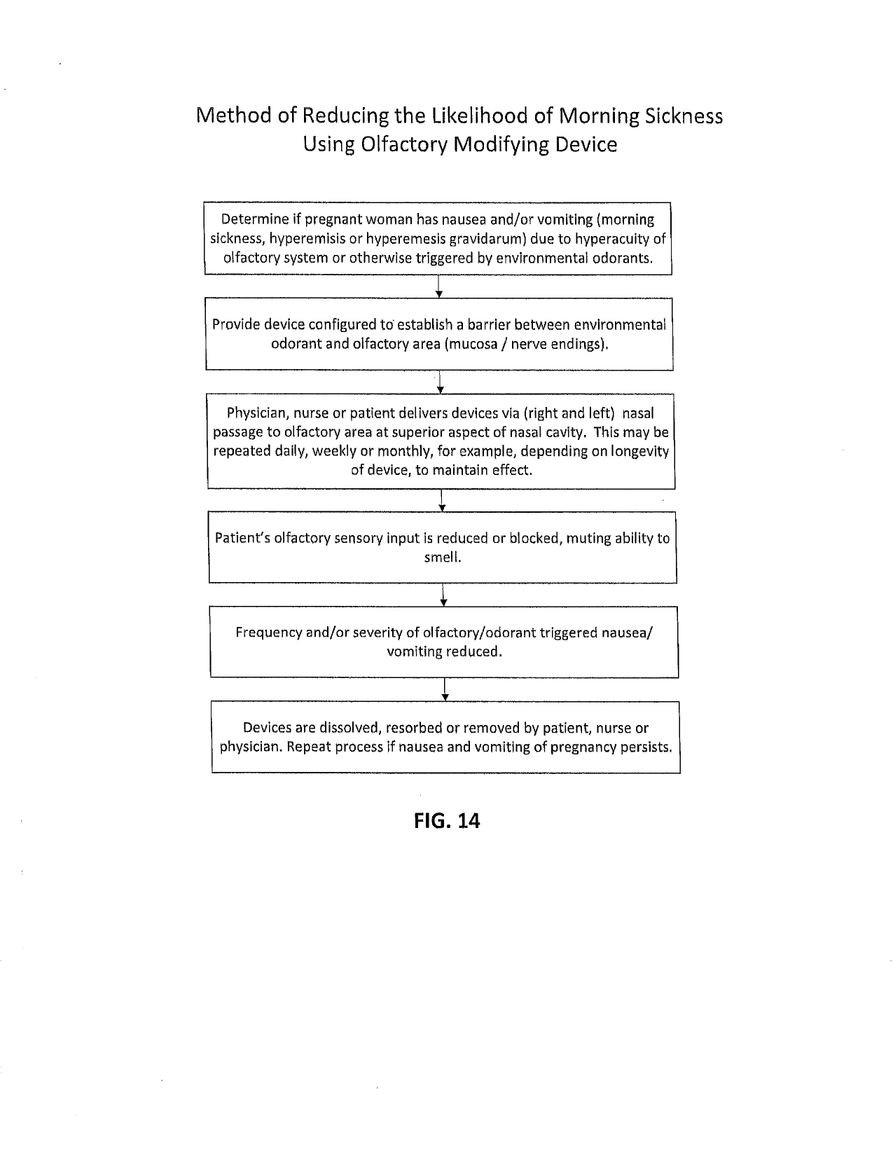

In another example, and with reference to FIG. 14, the olfactory devices disclosed herein may be used in a method of reducing the likelihood of nausea associated with, e.g., morning sickness. First, a physician, nurse or the patient determines if the symptoms of nausea and vomiting are triggered by odorants. This may be done by specific olfactory testing (e.g., smell sticks) or by discussing the circumstances of nausea and vomiting with the patient. If appropriate, a physician, nurse or the patient delivers olfactory devices via the (right and left) nasal passages to the olfactory area adjacent the superior aspect of the nasal cavity 2012. This may be repeated daily, weekly or monthly, for example, depending on the longevity of the olfactory device. The patient's olfactory senses are thus reduced or blocked, diminishing or muting the patient's ability to smell. Consequently, because exposure of the olfactory area to the trigger has been eliminated or at least reduced, the frequency and/or severity of olfactory-triggered nausea/vomiting are correspondingly reduced. By full gestation or by the initiation of labor, the olfactory modifying devices may be resorbed, dissolved or degraded, or removed by a physician, nurse or the patient.

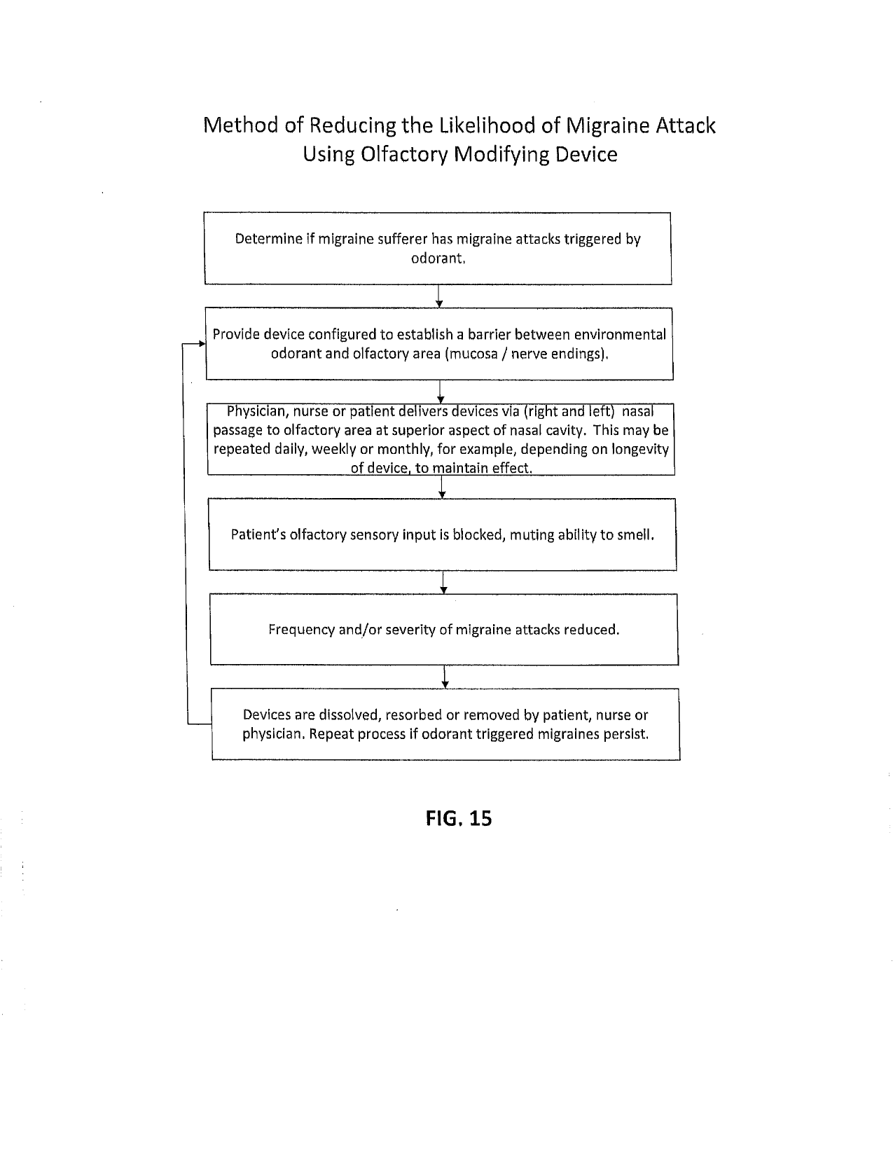

In another example, and with reference to FIG. 15, the olfactory devices disclosed herein may be used in a method of reducing the likelihood of a migraine headache attack. First, a physician, nurse or the patient determines if the migraine attacks triggered by odorants. This may be done by specific olfactory testing (e.g., smell sticks) or by discussing the circumstances of migraine attack with the patient. If appropriate, a physician, nurse or the patient delivers olfactory devices via the (right and left) nasal passages to the olfactory area adjacent the superior aspect of the nasal cavity 2012. This may be repeated daily, weekly or monthly, for example, depending on the longevity of the olfactory device. The patient's olfactory senses are thus reduced or blocked, diminishing or muting the patient's ability to smell. Consequently, because exposure of the olfactory area to the trigger has been eliminated or at least reduced, the frequency and/or severity of olfactory-triggered migraines attacks are correspondingly reduced. Over time, the device may be resorbed, dissolved or degraded, or removed by a physician, nurse or the patient. The process may be repeated if olfactory-triggered migraine attacks return.

Further alternative embodiments are also envisioned.

One embodiment includes a device that carries a mucus-thickening agent. The device is placed in the nasal cavity in the olfactory area as described previously. Rather than providing a barrier to the olfactory area, it thickens the olfactory mucus to reduce transport of odorants.

Another embodiment includes a device that carries a mucosal-inflaming agent. The device is placed in the nasal cavity in the olfactory area as described previously. Rather than providing a barrier to the olfactory area, it causes inflammation of the mucous membrane to reduce transport of odorants.

Yet another embodiment is a method wherein the olfactory mucosa is removed (e.g., scraped, ablated, etc.) to compromise the olfactory nerve endings for a period of time until they heal.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the embodiments disclosed herein are not to be considered as limited by the foregoing description.

We claim:

1. A method of treating a patient with an olfactory-triggered condition, comprising:
placing an olfactory device over an olfactory area in a nasal cavity of the patient to mitigate the olfactory-triggered condition.

2. A method as in claim 1, further comprising diagnosing the patient's olfactory-triggered condition.

3. A method as in claim 2, wherein the olfactory-triggered condition comprises nausea and vomiting.

4. A method as in claim 2, wherein the olfactory-triggered condition comprises migraine headache.

5. A method as in claim 2, wherein the olfactory-triggered condition comprises over-eating.

6. A method as in claim 2, wherein the olfactory device is placed superior to an inferior turbinate to allow free breathing across the inferior turbinate.

7. A method as in claim 2, wherein the olfactory device is placed superior to an inferior turbinate and a middle turbinate to allow free breathing across the middle turbinate and the inferior turbinate.

8. A method as in claim 2, wherein the olfactory device is placed adjacent an olfactory mucosa.

9. A method as in claim 2, wherein the olfactory device is placed in an apex of the nasal cavity.

10. A method as in claim 2, wherein a first olfactory device is placed in the patient's right nasal cavity and a second olfactory device is placed in the patient's left nasal cavity.

11. A method as in claim 2, wherein the olfactory device comprises a non-absorbent material.

12. A method as in claim 2, wherein the olfactory device is expandable from a smaller delivery configuration to a larger deployed configuration.

13. A method as in claim 2, wherein the olfactory device comprises a material configured to dissolve in-situ.

14. A method as in claim 2, wherein the olfactory device comprises a material that resorbs in-situ.

15. A method as in claim 2, wherein the olfactory device comprises an aerosol spray configured to be applied as a film covering at least a portion of an olfactory mucosa.

16. A method as in claim 2, wherein the olfactory device comprises a liquid configured to be applied as a film covering at least a portion of an olfactory mucosa.

17. A method as in claim 2, wherein the olfactory device comprises a gel configured to be applied as a film covering at least a portion of an olfactory mucosa.

18. A method as in claim 2, wherein the olfactory device comprises closed-cell foam covering at least a portion of an olfactory mucosa.

19. A method as in claim 2, wherein the olfactory device comprises an expandable stent structure and a membrane covering at least a portion of an olfactory mucosa.

20. A method as in claim 2, wherein the olfactory device is delivered via an elongate member inserted into the nasal cavity.

21. A method as in claim 2, wherein the olfactory device is delivered via an elongate member inserted into the nasal cavity, and wherein, during insertion a distal curvature of the elongate member is advanced along an anterior wall of the nasal cavity maintaining intimate contact therewith until a distal end of the elongate member encounters a significant increase in resistance, indicating the distal end thereof is abutting a posterior-superior angle of the nasal cavity.

22. A method of treating a patient with an olfactory-triggered condition, comprising:
diagnosing the patient's olfactory-triggered condition; and
in response to the diagnosis, placing an olfactory device in the patient's nasal vestibule, the olfactory device defining an opening to permit free breathing therethrough when placed in the nasal vestibule, the olfactory device emanating a benign odorant that masks a culprit odorant to mitigate the olfactory-triggered condition.

23. A method as in claim 22, wherein the olfactory device is substantially ring-shaped.

24. A method of treating a patient with an olfactory-triggered condition, comprising:
diagnosing the patient's olfactory-triggered condition; and
in response to the diagnosis, placing a baffle olfactory device in the patient's nasal cavity inferior to the patient's olfactory area, the baffle olfactory device re-directing airflow through the nasal cavity away from the olfactory area to mitigate exposure of the olfactory area to a triggering odorant thereby mitigating the olfactory-triggered condition.

25. A method of inhibiting exposure of a person's olfactory area to harmful or irritable airborne matter by placing a barrier over the person's left and right olfactory mucosa.
